(19) United States
(12) Patent Application Publication
(10) Pub. No.: US 2014/0171841 A1
(43) Pub. Date: Jun. 19, 2014

(54) Vibrator

(71) Applicant: SOS NOVELTIES, INC, Duarte, CA (US)

(72) Inventors: Ovakim Kazaryan, Duarte, CA (US); Tim Nugent, Culver City, CA (US)

(73) Assignee: SOS NOVELTIES, INC, Duarte, CA (US)

(21) Appl. No.: 13/718,895

(22) Filed: Dec. 18, 2012

(51) Int. Cl. A61H 1/00

(52) U.S. Cl. CPC A61H 1/00
USPC 601/46

(57) ABSTRACT

A device is disclosed. The device contains a housing with a power source, and a removable massaging head with a vibrating unit, wherein the vibrating unit is powered by the power source.

### FIELD

The present invention relates to a personal massager (i.e. vibrator).

### BACKGROUND

Sexual self-stimulators, principally in the form of vibrators, have been available for a long time. Examples of such devices are described in a substantial volume of patent literature, including U.S. Pat. No. 3,451,391, which issued to J. H. Tavel on Jun. 24, 1969; U.S. Pat. No. 3,504,665, which issued to M. I. Bakunin et al on Apr. 7, 1970; U.S. Pat. No. 3,991,751, which issued to J. O. O'Rourke on Nov. 16, 1976; U.S. Pat. No. 4,033,338, which issued to K. Igwebiki on Jul. 5, 1977; U.S. Pat. No. 5,067,480, which issued to P-G. E. Woog et al on Nov. 16, 1991; and U.S. Pat. No. 5,470,303, which issued to Leonard on Nov. 28, 1995 which are all incorporated herein by reference.

Referring to FIGS. 1-2, as known in the art, a vibrator 10 comprises a substantially tubular housing 1 dimensioned to be held in a hand and having an open neck end 2. The vibrator 10 also comprises a head 3 removably affixed to the housing 1 at the neck end 2. The housing 1 further comprises an electric vibrating device 8 for vibrating the head 3. The vibrating device 8 may be powered by any suitable source of electrical energy 9, such as, for example, a stepdown transformer connected to a commercial power source, or any suitable type of battery or batteries. The source of electrical energy 9 is also disposed within the housing 1. The removable head 3 may be replaced by one of the heads 5 and/or 6 as shown in FIGS. 3-4.

Because the vibrating device 8 and the source of electrical energy 9 are both disposed within the housing 1, each removable head 3, 5 and 6 will vibrate (i.e. operate) at the same speed (or range of speeds) and/or at the same vibrating strength. This is not well-suited when different users (for example women) often have different sensitivities and may require the removable head 3, 5 and 6 to operate at higher or lower speeds and/or vibrating strength. Furthermore, the removable heads 3, 5 and 6 have different shapes. Using the same vibrating device 8 to operate (i.e. vibrate) the differently shaped heads 3, 5 and 6 does not take full advantage of each heads unique shape (i.e. features).

Therefore, a need exists for a vibrator that overcomes the deficiencies of the prior art as described above.

### BRIEF DESCRIPTION OF THE FIGURES

FIG. 1 depicts a perspective view of an embodiment of the portable vibrator as known in the art.

FIG. 2 depicts part of the embodiment of FIG. 1.

FIGS. 3-4 depict different heads to be used with the embodiment of FIG. 1.

FIGS. 5-6 depict a massaging unit according to the present disclosure.

FIGS. 7-8 and 10 depict internal components of the embodiment of FIGS. 5-6.

FIG. 9 depicts a vibrating head of the embodiment of FIGS. 5-6.

FIGS. 11-13 depict a charging station according to the present disclosure.

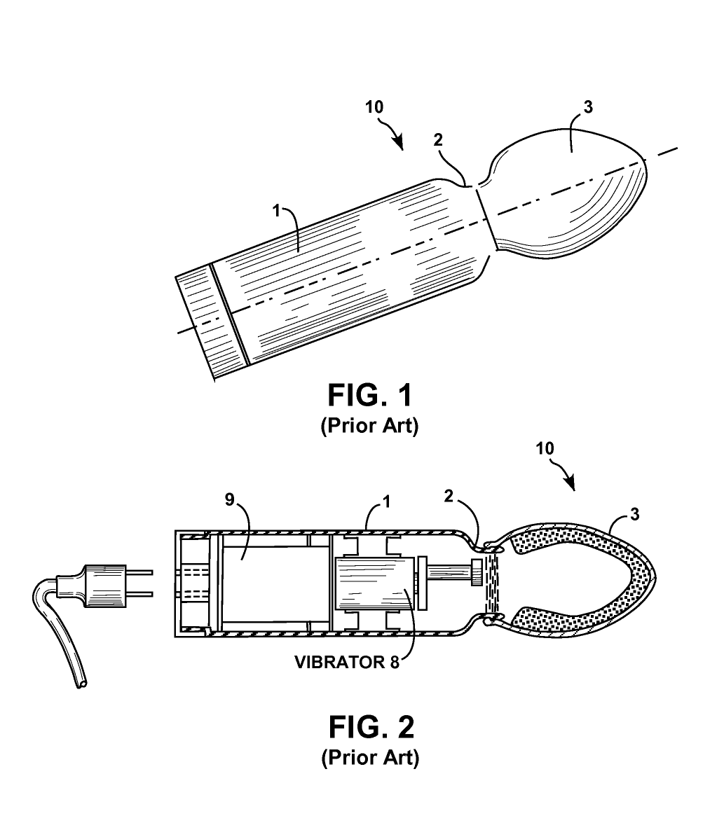

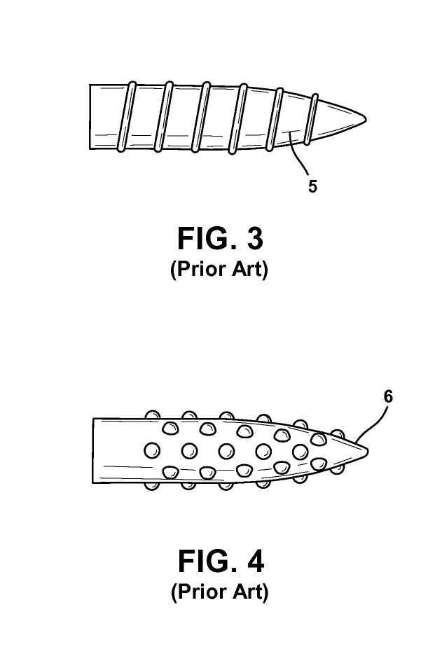

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements, and are not drawn to scale.

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

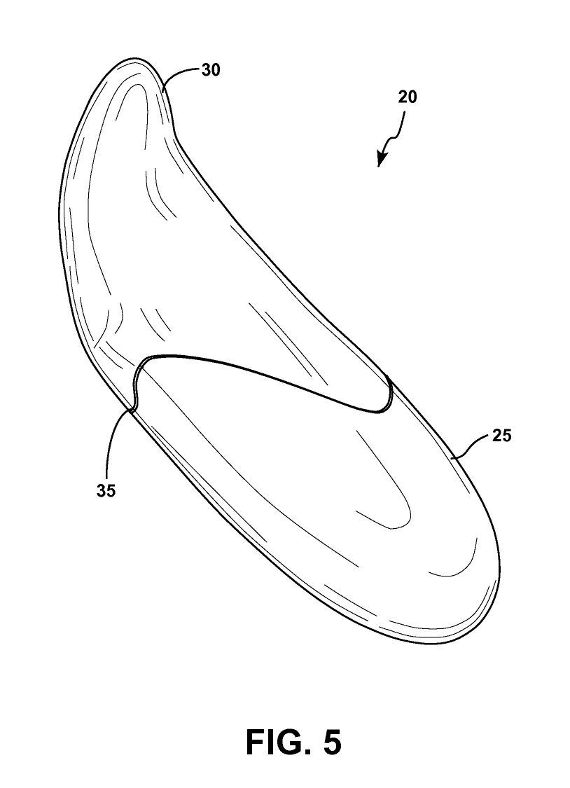

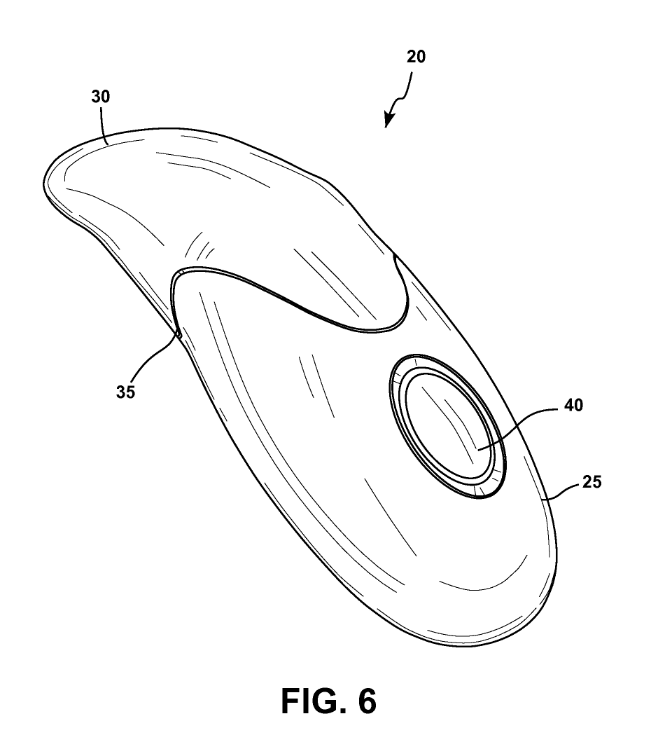

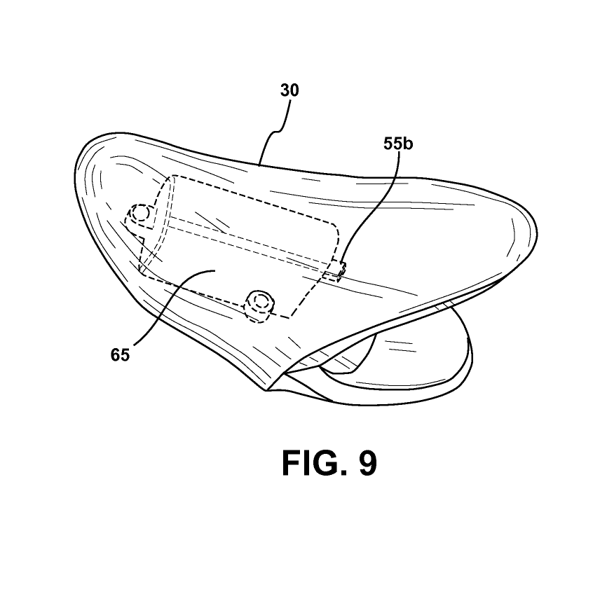

Referring to FIGS. 5-6, a vibrating (i.e massaging) unit 20 is depicted according to one embodiment of the present disclosure. The unit 20 is defined by a housing 25 and a massage (i.e. vibrating) head 30 (as shown in FIG. 9). The head 30 is connected with one end 35 of the housing 25. The housing 25 comprises a power switch 40 (as shown in FIG. 6) to turn the unit 20 on and off. The switch 40 may be a sliding switch or a push switch configured to move up and down.

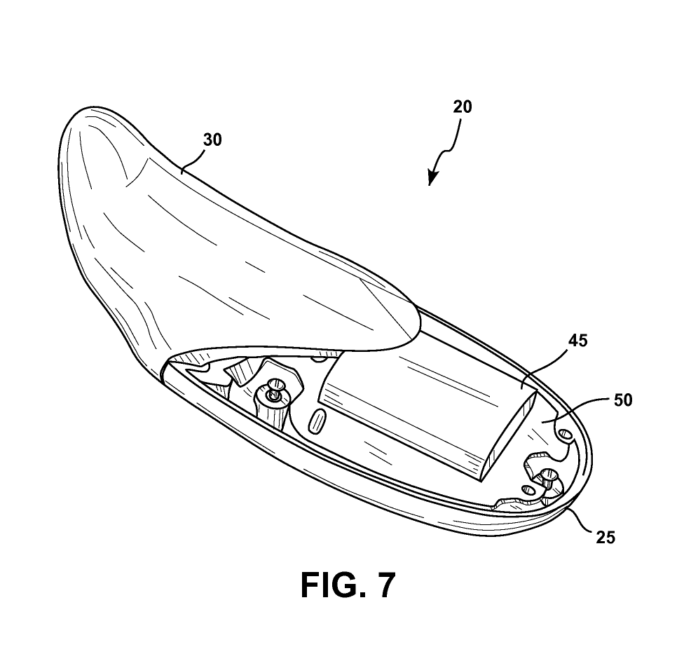

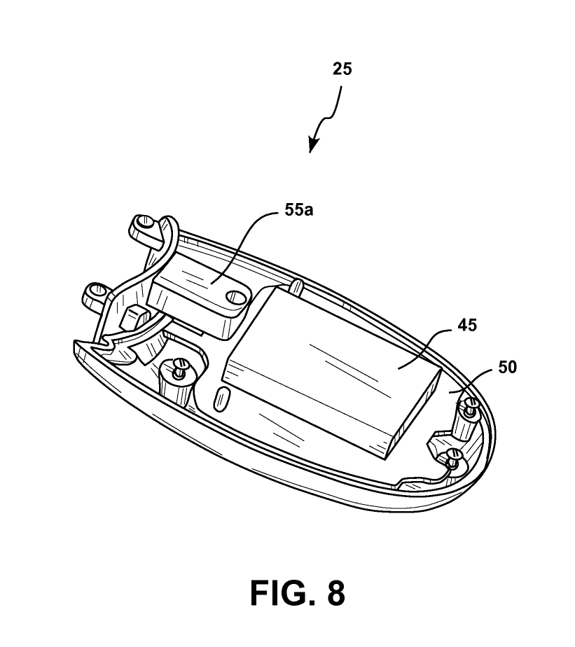

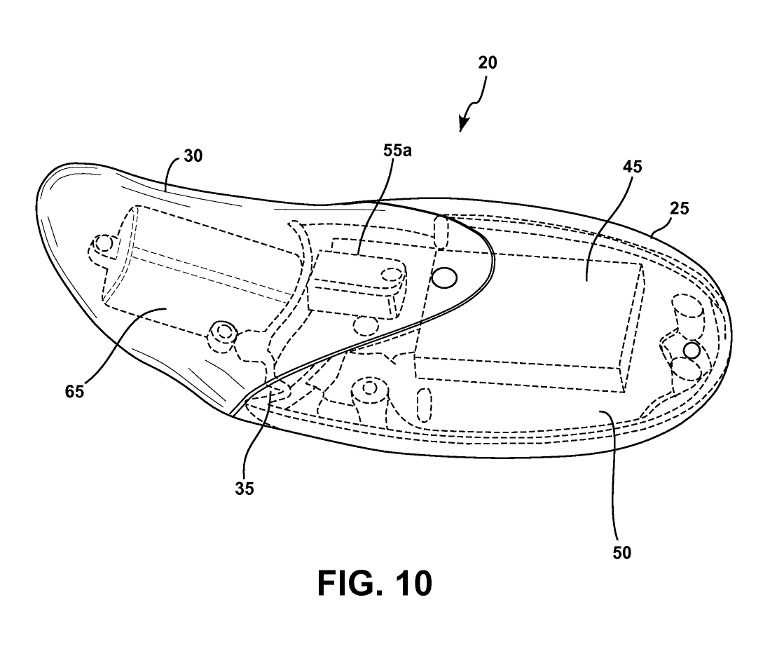

The interior of the housing 25 houses a power source 45, a printed circuit board 50, and a connector 55a as shown in FIGS. 7-8. The power source 45 may be, for example, a re-chargeable battery. The printed circuit board 50 may be in electrical contact with the power switch 40 and the power source 45. When the power switch 40 is turned on, the printed circuit board 50 is configured to activate a vibrating unit 65 disposed with the massage head 30 as shown in FIGS. 9-10. The vibrating unit 65 may be, for example, a motor. In one embodiment, the housing 25 and the massage head 30 are electrically coupled with each other at least through the connectors 55a and 55b. The connectors 55a-b may be, for example, bourn connectors.

In one embodiment, the housing 25 comprises high-impact polystyrene (HIPS) material and/or acrylonitrile butadiene styrene (ABS) material; and the massage head 30 comprises silicone FDA approved material with soft touch finish.

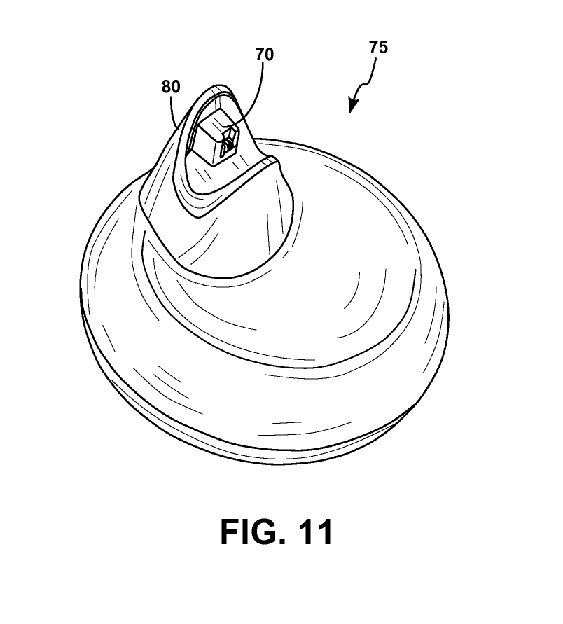

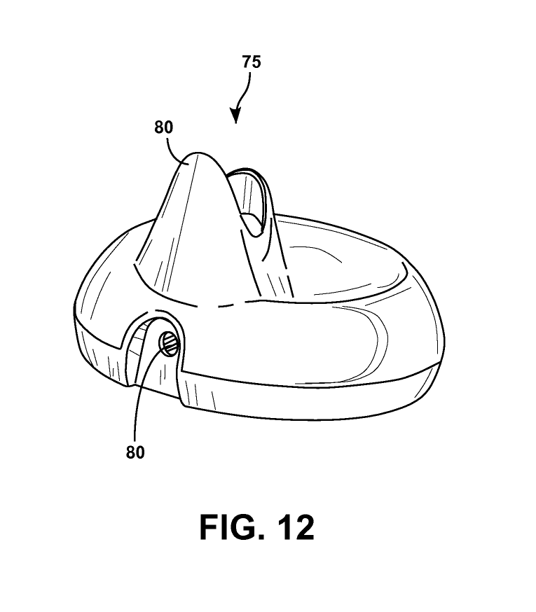

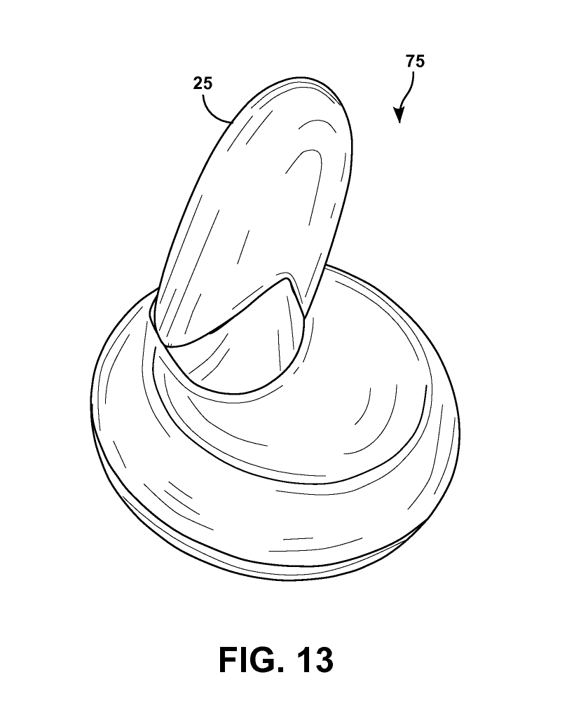

In another embodiment, the power source 45 is charged (i.e. recharged) by coupling the connector 55a to a connector 70 of a charging station 75 depicted in FIGS. 11-13. In one embodiment, the connector 70 is the same as the connector 55b associated with the massage head 30. The charging station 75 comprises a holding area 80 configured to accommodate the housing 25 while the power source 45 is being charged. The charging station 75 further comprises a jack 80 for providing power to the charging station 75 from, for example, a commercial power source (not shown). The housing of the charging station 75 may comprise HIPS and/or ABS materials.

Unlike prior art, the vibrating unit 20 presently disclosed allows the users to purchase differently massaging heads without having to replace the housing 25. It is to be understood that the massaging heads configured to be compatible with the housing 25 may comprise vibrating units having different speeds and/or vibrating strength. Furthermore, the massaging heads configured to be compatible with the housing 25 may comprise vibrating units having performance characteristics that are compatible with the shape of the massaging heads. Finally, because the housing 25 is charged by the charging station 75 without the massaging head 30, the user of the unit 20 will not be embarrassed to leave it on their night stand when the guests are visiting.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for. . . ” and no method or process step herein is to be construed under those provisions unless the step, or steps, are expressly recited using the phrase “step(s) for . . . .”

What is claimed is:

1. A device comprising:
a housing comprising a power source;
a removable massaging head comprising a vibrating unit, wherein the vibrating unit is powered by the power source.

2. The device of claim 1, further comprising a connector for coupling the housing with the removable massaging head.

3. The device of claim 1 wherein the power source is a re-chargeable battery.

4. The device of claim 2, further comprising a charging station configured to couple with the connector and charge the power source.

5. A method comprising:
removing a first massaging head from a housing, wherein the first massaging head comprises a first vibrating unit and the housing comprises a power source for providing power to the first vibrating unit; and
coupling a second massaging head with the housing, wherein the second massaging head comprises a second vibrating unit, wherein the power source is configured to provide power to the second vibrating unit.

6. The method of claim 5, further comprising coupling the housing to a charging station to recharge the power source.

7. A system comprising:
a housing comprising a power source; and
two or more removable massaging heads configured to be coupled with the housing, wherein each massaging head comprises a vibrating unit, wherein the power source provides power to vibrating unit associated with one of the two or more removable massaging heads coupled with the housing.

8. The system of claim 7, further comprising a connector for coupling the housing with the two or more removable massaging heads.

9. The system of claim 7, wherein the power source is a re-chargeable battery.

10. The system of claim 8, further comprising a charging station configured to couple with the connector and charge the power source.
